(19) United States
(12) Patent Application Publication
(10) Pub. No.: US 2019/0295086 A1
(43) Pub. Date: Sep. 26, 2019

(54) QUANTIFYING DEVICE RISK THROUGH ASSOCIATION

(71) Applicant: CA, Inc., New York, NY (US)

(72) Inventors: Himanshu ASHIYA, Bangalore (IN); Gaurav AGARWAL, Bangalore (IN); Atmaram Prabhakar SHETYE, Bangalore (IN)

(73) Assignee: CA, Inc.

(21) Appl. No.: 15/934,407

(22) Filed: Mar. 23, 2018

(51) Int. Cl. G06Q 20/40; G06Q 20/32

(52) U.S. Cl. CPC G06Q 20/4016; G06Q 20/32

(57) ABSTRACT

A method includes determining, for each device in a first set of devices associated with a fraudulent transaction initiated by a plurality of flagged accounts, a suspicion score based on a number of fraudulent transactions associated with the device. The method also includes determining a relationship between each device in the first set and other devices in a second set that have initiated at least one legitimate transaction using at least one of the plurality of flagged accounts. The method further includes determining, for each device in the second set, an average suspicion score based on the suspicion score for each device in the first set that is related to the device in the second set. The method still further includes determining that the average suspicion score for a particular device in the second set is above a threshold, and blocking a pending transaction involving the particular device.

### BACKGROUND

The present disclosure relates to quantifying device risk, and specifically to quantifying device risk through association.

### BRIEF SUMMARY

According to an aspect of the present disclosure, a method includes determining, for each device in a first set of devices associated with a fraudulent transaction initiated by a plurality of flagged accounts, a suspicion score based on a number of fraudulent transactions associated with the device. A relationship is determined between each device in the first set and other devices in a second set that have initiated at least one legitimate transaction using at least one of the plurality of flagged accounts. For each device in the second set, an average suspicion score is determined based on the suspicion score for each device in the first set that is related to the device in the second set. In response to determining that the average suspicion score for a particular device in the second set is above a threshold, a pending transaction involving the particular device is blocked, or some further action is taken.

Other features and advantages will be apparent to persons of ordinary skill in the art from the following detailed description and the accompanying drawings.

### BRIEF DESCRIPTION OF THE DRAWINGS

Aspects of the present disclosure are illustrated by way of example and are not limited by the accompanying figures with like references indicating like elements of a non-limiting embodiment of the present disclosure.

FIG. 1 is a high-level diagram of a computer network.

FIG. 2 is a high level block diagram of a computer system.

FIG. 3 is a flowchart for quantifying device risk through association illustrated in accordance with a non-limiting embodiment of the present disclosure.

FIG. 4 is a flowchart for quantifying device risk through association illustrated in accordance with a non-limiting embodiment of the present disclosure.

FIG. 5 is a diagram illustrating levels of relationships between payment devices in accordance with a non-limiting embodiment of the present disclosure.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely in software (including firmware, resident software, micro-code, etc.) or in a combined software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would comprise the following: a portable computer diskette, a hard disk, a random access memory (“RAM”), a read-only memory (“ROM”), an erasable programmable read-only memory (“EPROM” or Flash memory), an appropriate optical fiber with a repeater, a portable compact disc read-only memory (“CD-ROM”), an optical storage device, a magnetic storage device, or any suitable combination of the foregoing. In the context of this document, a computer readable storage medium may be any tangible medium able to contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take a variety of forms comprising, but not limited to, electro-magnetic, optical, or a suitable combination thereof. A computer readable signal medium may be a computer readable medium that is not a computer readable storage medium and that is able to communicate, propagate, or transport a program for use by or in connection with an instruction execution system, apparatus, or device. Program code embodied on a computer readable signal medium may be transmitted using an appropriate medium, comprising but not limited to wireless, wireline, optical fiber cable, RF, etc., or any suitable combination of the foregoing.

Computer program code for carrying out operations for aspects of the present disclosure may be written in a combination of one or more programming languages, comprising an object oriented programming language such as JAVA®, SCALA®, SMALLTALK®, EIFFEL®, JADE®, EMERALD®, C++, C#, VB.NET, PYTHON® or the like, conventional procedural programming languages, such as the “C” programming language, VISUAL BASIC®, FORTRAN® 2003, Perl, COBOL 2002, PHP, ABAP®, dynamic programming languages such as PYTHON®, RUBY® and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider) or in a cloud computing environment or offered as a service such as a Software as a Service (“SaaS”).

Aspects of the present disclosure are described herein with reference to flowchart illustrations and/or block diagrams of methods, apparatuses (e.g., systems), and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks. Each activity in the present disclosure may be executed on one, some, or all of one or more processors. In some non-limiting embodiments of the present disclosure, different activities may be executed on different processors.

These computer program instructions may also be stored in a computer readable medium that, when executed, may direct a computer, other programmable data processing apparatus, or other devices to function in a particular manner, such that the instructions, when stored in the computer readable medium, produce an article of manufacture comprising instructions which, when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses, or other devices to produce a computer implemented process, such that the instructions which execute on the computer or other programmable apparatus provide processes for implementing the functions/acts specified in the flowchart and/or block diagram block or blocks.

Consumers expect safe, transparent online shopping experiences. However, authentication requests may cause those consumers to abandon certain transactions, resulting in lost interchange fees for the issuer. Card issuers often strive to minimize customer friction and provide security for Card Not Present (CNP) payment transactions to protect cardholders from fraud and reduce the liability associated with losses stemming from those fraudulent transactions. payment processing agents strive to minimize cardholder abandonment, which could potentially result in lost interchange fee revenue. Additionally, when customers are inundated with authentication requests for a particular account, those customers may seek alternative forms of payment, leading to additional lost interchange fee revenue. To this same effect, high volumes of customer service inquiries can increase operational costs and impact budgets.

Payment processors also seek to reduce instances of “fully authenticated” fraud. This type of fraud occurs in the face of enhanced authentication procedures as a result of the fraudulent participant capturing the target's full authentication information. These types of fraud levy steep costs on payment processing agents including liability for the fraudulent payment to the merchant or cardholder and operational expenses incurred from processing fraudulent transactions.

In certain embodiments, risk analytics platforms provide transparent, intelligent risk assessment and fraud detection for CNP payments. Such a platform makes use of advanced authentication models and flexible rules to examine current and past transactions, user behavior, device characteristics and historical fraud data to evaluate risk in real time. The calculated risk score is then used in connection with payment processing agent policies to automatically manage transactions based on the level of risk inherent in each transaction. For example, if the transaction is determined to be low risk, the systems and rules allow the transactions to proceed, thus allowing the majority of legitimate customers to complete their transactions without impact. Similarly, potentially risky transactions are immediately challenged with additional authentication steps. In certain embodiments, those risky transactions can be denied. A comprehensive case management system provides transparency to all fraud data allowing analysts to prioritize and take action on cases. In particular embodiments, a database of fraudulent activity is provided for inquiry and access of additional information regarding suspicious or fraudulent transactions. Thus, historical fraudulent data is readily queryable and made available to payment processing agents to support customer inquiries.

In certain embodiments, the risk analytics system uses sophisticated behavioral modeling techniques to transparently assess risk in real-time by analyzing unique authentication data. For example, the system may manage and track transaction information including device type, geolocation, user behavior, and historical fraud data to distinguish genuine transactions from true fraud.

Particularly, in certain embodiments, devices associated with at least one known instance of fraud are identified. Those devices are flagged as fraudulent devices, or “level 0” devices. For example, the identification may be based on a unique device identifier, cookie, MAC address, IP address, or any combination thereof in order to uniquely identify a device. For example, the devices in question may include mobile payment devices such as mobile phones, computers used to initiate an e-commerce transaction, or any device used in transacting in a CNP transaction. Transaction traffic involving those devices that are associated with instances of known fraud is inspected to identify relationships with other devices. For example, a relationship with another device may be determined if an account used to conduct a transaction on a level 0 fraudulent device is used on another device. Other relationship factors can also be considered. Related devices are categorized as “level 1” suspicious devices. In certain embodiments, still other devices associated with or related to level 1 suspicious devices are determined and classified as “level 2” devices. For example, those relationships or associations may be determined with the same criteria as the level 1 relationships. For example, other devices that have consummated a transaction from an account associated with a level 1 device can be categorized as a level 2 device. In certain embodiments, the relationship mapping may continue on until every device is classified. In certain embodiments, devices that have no relationship to the underlying level 0 devices can be classified as safe devices.

In particular embodiments, scores that estimate the propensity of a device to participate in a fraudulent transaction are generated for level 0 devices. These scores can be referred to as suspicion scores. For example, the suspicion scores can be derived by reference to the historical fraudulent transaction data for a given device. In certain embodiments, the suspicion score is derived based on a number of fraudulent transactions for a given device. The sore may be percentage of fraudulent transactions against a total number of transactions attributable to a specific device. As another example, the suspicion score can be a categorization based on an absolute number of fraudulent transactions against a threshold. For example, if a device has 3 or more instances of fraud, the suspicion score may be 100%, while if the device has 2 instances of fraud, the suspicion score may be 75%. Various other configurations of device scoring are contemplated by the present disclosure and the disclosure should not be limited by these examples.

In particular embodiments, an average suspicion score is determined for each device in each level. The average suspicion score takes the average of all related devices in the next level down. For example, for level 1 devices, the average suspicion score is an average of the suspicion scores for all related devices in the level 0 category. In this example, “related devices” refer to those devices where a same account has transacted or logged into each device. Similarly, the average suspicion scores can be calculated on down the line through level 2, 3, 4, etc. devices. For example, level 2 device average suspicion scores are calculated with reference to related device average suspicion scores for level 1 devices. Particularly, the level 2 device score is an average of all suspicion scores for related devices in level 1.

In particular embodiments, a dampening factor or weighting is applied to the average suspicion scores at each level. For example, the dampening factor may reduce the calculated average suspicion score by some predetermined amount relative to the distance between the level 0 device and the current device level. For example, a dampening factor of 0.75 may be applied to the average suspicion scores from level 1 devices, while a dampening factor of 0.5 can be applied to the average suspicion scores from level 2 devices. In certain embodiments, the average suspicion score is calculated for each device in each level without applying the dampening factors. The dampening factors are then applied as a final step. In certain embodiments, the dampening factors are applied during calculation of the suspicion scores.

In particular embodiments, various actions are taken by the transaction processing agents in response to determining that a device suspicion score, or average suspicion score, is above or below a threshold. For example, for suspicion scores that are below a threshold, the transaction processing may proceed without interruption. However, in certain instances, enhanced logging may take place. For example, more transaction details can be collected for transactions with suspicion scores within a predetermined range. Thus, the payment processor may be sensitive to over-authentication concerns by the user while increasing surveillance or data collection regarding these transactions in case the transaction turns out to be fraudulent after processing. As another example, for devices with very high suspicion scores or average suspicion scores, the payment processing system may block the transaction. As another example, enhanced authentication procedures can be initiated and finely tuned to the level of suspicion associated with the device.

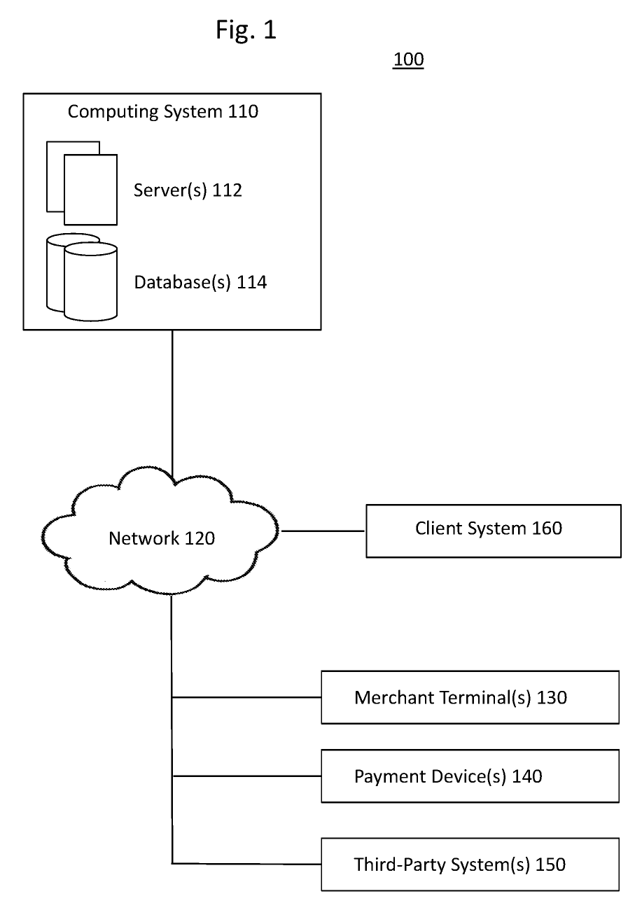

With reference to FIG. 1, a high level block diagram of a computer network 100 is illustrated in accordance with a non-limiting embodiment of the present disclosure. Network 100 includes computing system 110 which is connected to network 120. The computing system 110 includes servers 112 and data stores or databases 114. For example, computing system 110 may host a payment processing server or a risk analytics process for analyzing payment processing data. For example, databases 114 can store transaction history information, such as history information pertaining to transactions and devices. Network 100 also includes client system 160, merchant terminal 130, payment device 140, and third party system 150, which are each also connected to network 120. For example, a user may use peripheral devices connected to client system 160 to initiate e-commerce transactions with vendor websites, such as third party systems 150 or merchant terminals 130. As another example, a user uses a payment device 140 to initiate transactions at merchant terminal 130. In certain embodiments, a payment processing agent is involved in approving each transaction. The steps involved in interfacing with the credit issuing bank are omitted, but can be accomplished through network 120 and computing system 110 and additional computing systems. In certain embodiments, the above described transaction activity is analyzed and stored by computing system 110 in databases 114. Those of ordinary skill in the art will appreciate the wide variety of configurations possible for implementing a risk analytics platform as described in the context of the present disclosure. Computer network 100 is provided merely for illustrative purposes in accordance with a single non-limiting embodiment of the present disclosure.

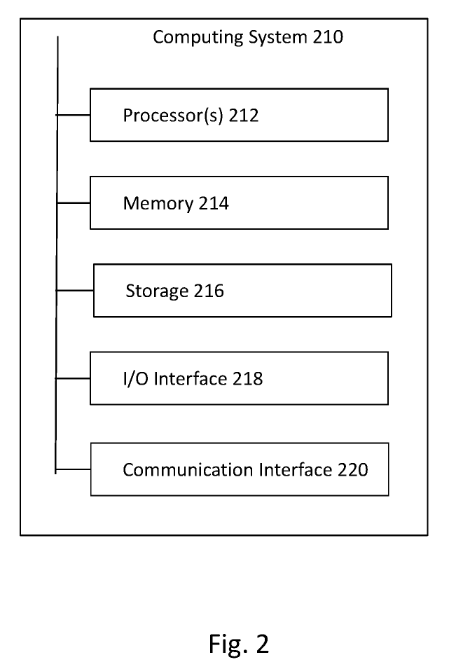

With reference to FIG. 2, a computing system 210 is illustrated in accordance with a non-limiting embodiment of the present disclosure. For example, computing system 210 may implement a payment processing and/or risk analytics platform in connection with the example embodiments described in the present disclosure. Computing system 210 includes processors 212 that execute instructions loaded from memory 214. In some cases, computer program instructions are loaded from storage 216 into memory 214 for execution by processors 212. Computing system 210 additional provides input/output interface 218 as well as communication interface 220. For example, input/output interface 218 may interface with one or more external users through peripheral devices while communication interface 220 connects to a network. Each of these components of computing system 210 are connected on a bus for interfacing with processors 212 and communicating with each other.

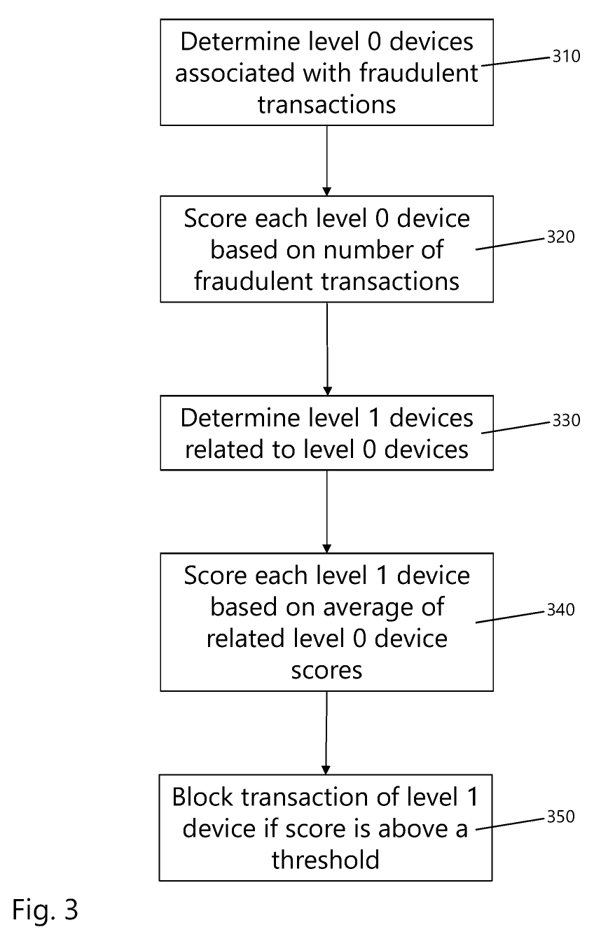

Turning now to FIG. 3, a flow chart of a method for quantifying device risk through association is illustrated in accordance with a non-limiting embodiment of the present disclosure. At step 310, level 0 devices are determined. For example, devices may be identified as level 0 devices if the device has been associated with one or more previous fraudulent transactions. As another example, level 0 devices can be identified as those devices which qualify as the highest risk devices by some other metric. For example, a machine learning model can be employed to identify high-risk devices. The high-risk devices can then be labeled as level 0 devices, even if those devices have not been previously associated with fraud. Those of ordinary skill in the art will understand the applicability of the relationship determination to any base set of devices. For example, the teachings of the present disclosure may be applied to derive suspicion scores and take additional actions during processing of transactions based on relationships to those devices. In particular embodiments, level 0 devices may be level 0 accounts. In other words, the teachings of the present disclosure may be applied to determining relationships between accounts instead of relationships between devices. In particular embodiments, some combination of both is employed to determine relationships between devices and/or accounts at the various levels of distinction.

At step 320, each level 0 device is scored. For example, each level 0 device can be scored with a score that reflects either in whole or in part the number of fraudulent transactions. For example, the score may be referred to as a suspicion score. The suspicion score may, in certain implementations, be a percentage of a number of fraudulent transactions with respect to a total number of transactions on a device (fraudulent and not-fraudulent). In certain embodiments, the number of fraudulent transactions may be instances of confirmed fraud, where a user has reported a transaction as fraudulent and some agent has confirmed the fraudulent nature of the activity. In particular embodiments, the fraudulent transactions are confirmed by a machine learning algorithm that is trained to identify fraudulent transactions. The machine learning model may be either supervised or unsupervised. The total number of transactions includes a total number of fraudulent and non-fraudulent transactions involving the particular device. In certain embodiments, the suspicion score may be a ratio. For example, the ratio may reflect the number of fraudulent transactions against the number of non-fraudulent transactions. For example, if a particular device has been associated with 10 fraudulent transactions and 2 legitimate transactions, the suspicion score for that device would be 5. Suspicion scores of less than 1 reflect devices with more legitimate transactions than fraudulent. Those of ordinary skill in the art will appreciate the wide variety of scoring systems possible for assigning level 0 devices with suspicion scores.

At step 330, level 1 devices are determined. In certain embodiments, level 1 devices are related to level 0 devices by some defined relationship. For example, the defined relationship may be that level 1 devices have been subject to at least one log in by an account that has also logged into a device on one or more level 0 accounts. In certain embodiments, even accounts that have been associated with fraudulent activity can be used in this assessment. For example, an account commits an instance of known fraud on a level 0 device, and then commits a legitimate transaction on a level 1 device. The common account used between the two devices supplies the relationship. The distinguishing factor between the devices in this instance is that the level 1 device has not had any instances of known fraud, whereas the level 0 device has. In the context of a real-life use case, this makes sense. For example, a user has his or her payment information stolen. The cyber-criminal uses that information for a fraudulent transaction on a different device. However, the user uses that same account to continue making legitimate transactions. That account supplies a relationship between the level 0 device (used in connection with the fraudulent transactions) and the level 1 device (the user's own device). Suspicion should be raised for those user transactions originating from the user's device, but the suspicion should be lower than the suspicion for the level 0 device(s) used by the fraudster.

In certain embodiments, the relationships may be based on additional criteria. For example, devices within a close geographic proximity to each other may be considered related to each other. For example, a level 1 relationship may exist between devices that are within a few meters of each other, simulating the boundaries of a household. Thus, the risk associated with devices that are geographically proximate to other known fraudulent devices can also be tracked.

In certain embodiments, the relationships may be based on other patterns derived from historical transaction data. For example, a unique pattern or trend in historical transaction data may be derived that links particular transactions on particular devices. While those devices may not have any other tangible relationship, the correlation between the purchase activity/pattern may be so strong as to draw a relationship between the devices, such as a level 0/1 relationship. Weaker correlations may receive a larger step, such as a level 0/2 relationship.

At step 340, each level 1 device is scored with a suspicion score. In particular embodiments, the suspicion score is an average suspicion score. For example, the average suspicion score may be an average of all related level 0 device suspicion scores. For example, since the average suspicion score is based in part on the number of fraudulent transactions that the device has initiated, levels greater than 0 may not have any means of calculating a base suspicion score. Accordingly, those devices calculate an average suspicion score that is an average of related device suspicion scores. For example, if a level 1 device is related to 3 level 0 devices through one or more of the relationship mechanisms described herein, the level 1 device suspicion score may be the average of those suspicion scores. As another example, the average suspicion score may be a function of the related device suspicion score as well as some multiplier that corresponds to the number of related level 0 devices. For example, since being related to more devices in level 0 may indicate a higher probability of fraudulent activity, the average suspicion score for a level 1 device may be multiplied by some variable that is a function of the number of related devices.

In certain embodiments, the average suspicion scores are calculated on up the relationship level hierarchy. For example, suspicion scores for level 2 devices are derived from related level 1 device suspicion scores. For example, the suspicion score for a level 2 device may be a function of the suspicion scores for related level 1 devices and some multiplier based on the actual number of related level 1 devices. In certain embodiments, the suspicion score is based on the number of related level 1 and level 0 devices and their suspicion scores.

In certain embodiments, a dampening factor or dampening multiplier is applied at each level such that suspicion scores are dampened or lessened as they are further removed from level 0 devices. For example, level 0 devices may receive no dampening factor. Level 1 devices, may receive a 0.8 dampening factor that is multiplied against the calculated suspicion score. Level 2 devices may receive a 0.6 dampening factor that is multiplied against their calculated suspicion scores. The dampening factor may continue on up the level hierarchy. Thus, the suspicion scoring system may account for the number of fraudulent transactions, relationships between devices, the number of related devices in each level, and the distance between the target device and the level 0 devices.

At step 350, some action is taken in response to a device initiating a transaction. In certain embodiments, the action is based on the suspicion score derived in the above described processes. For example, if the suspicion score for a particular device is above some threshold, the transaction may be blocked. If the suspicion score is within another window, additional authentication measures can be enforced. Thus, the system may take into account security concerns with the complex scoring calculation described above to quantify device risk while minimizing interruption to the user. For example, scoring mechanisms and thresholds can be modified or learned in order to balance these competing interests.

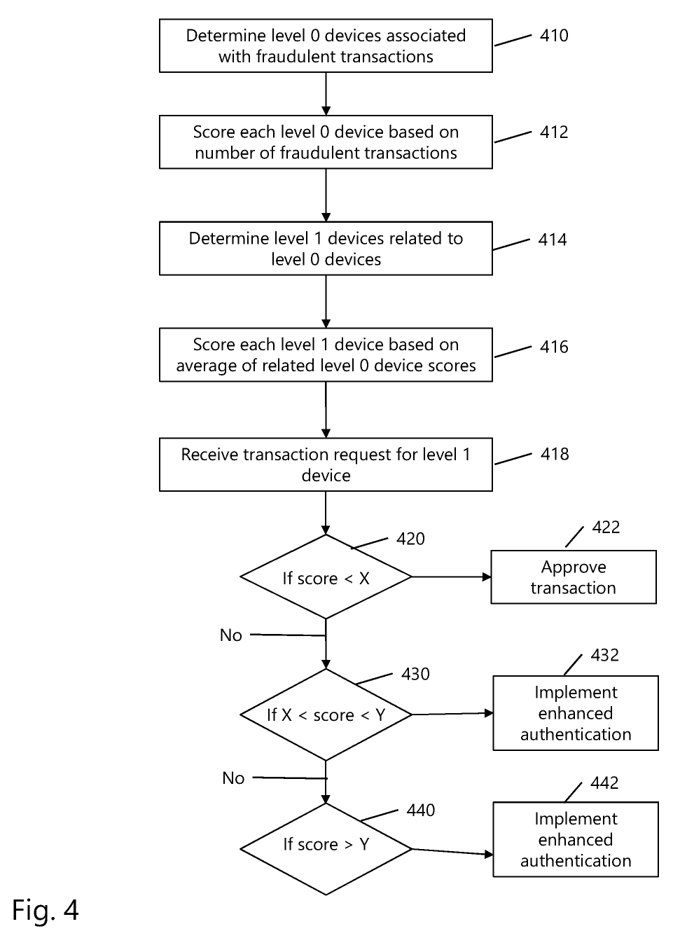

With reference to FIG. 4, a flow chart of a method for quantifying device risk is illustrated in accordance with a non-limiting embodiment of the present disclosure. With reference to step 410, level 0 devices are determined. In this example, level 0 devices are determined by reference to devices with known fraudulent activity. However, any suitable manner of identifying high risk devices may be employed, such as those described above, without departing from the scope of the present disclosure. For example, a fraudster uses legitimate account information to make a fraudulent transaction on a computer. The computer is flagged as being a fraudulent level 0 device. The account is also flagged as being associated with fraud. However, the system recognizes that the account may still be associated with legitimate transactions on devices that are more distant from the level 0 device. The scoring processes described herein are designed to quantify those risks.

At step 412 each level 0 device is scored based on a metric. In particular embodiments, the metric is tied to the number of fraudulent transaction invoked on the device. For example, the fraudster makes 3 fraudulent transaction on a level 0 device before the fraud is recognized and the account is suspended. The suspicion score accounts for this high level of fraud on this particular level 0 device. In certain embodiments, the transaction counter keeps running as additional fraudulent attempts are made after the account is suspended. Other devices associated with only 1 fraudulent attempt have a lower suspicion score in some instances.

At step 414, level 1 devices are determined based on a relationship to a level 0 device. The relationship may be determined in accordance with any of the above described implementations. For example, the relationship can be determined with respect to shared accounts across devices, as well as any other criteria such as criteria derived from historical transaction data.

At step 416, each level 1 device is scored. For example, the score may be based on an average of related device scores. A multiplier or weighting may be applied that quantifies the number of related devices, since the number of related devices may correlate to a higher fraud incidence.

At step 418, a transaction request for a particular level 1 device is received, and the rules for approving the transaction are implemented in connection with the individual score for that device. For example, the system may receive a request to process a transaction from a known device and may retrieve the suspicion score for that device in order to quantify the inherent level of risk associated with consummating the transaction. If the score is below a threshold level X, at step 420, the system proceeds to automatically approve the transaction at step 422. In certain embodiments, another threshold triggers enhanced monitoring of the device activity. For example, if the criteria is above some threshold, additional information is recorded regarding the transaction in order to support or enhance fraudulent transaction monitoring. In other words, since there is at least some indication that the transaction may be fraudulent, rather than disrupt the potentially legitimate user with enhanced authentication procedures, the system may instead trigger additional logging actions to log information such as geographic location, terminal location, price, item name, vendor, etc.

If the score is above the X threshold and below the Y threshold at step 430, enhanced authentication procedures are implemented at step 432. In certain embodiments, the enhanced authentication procedures may include two-way authentication, account verification questions, password prompting, and any other known authentication procedures or any combination thereof. If the score is above threshold Y at step 440, then even greater enhanced authentication, such as a combination of authentication procedures can be implemented at step 442. For example, password, and two level authentication may be required to approve a transaction on a device with such a high suspicion score. In certain embodiments, these transactions may be flat out blocked if the suspicion score is high enough until further authentication procedures are satisfied.

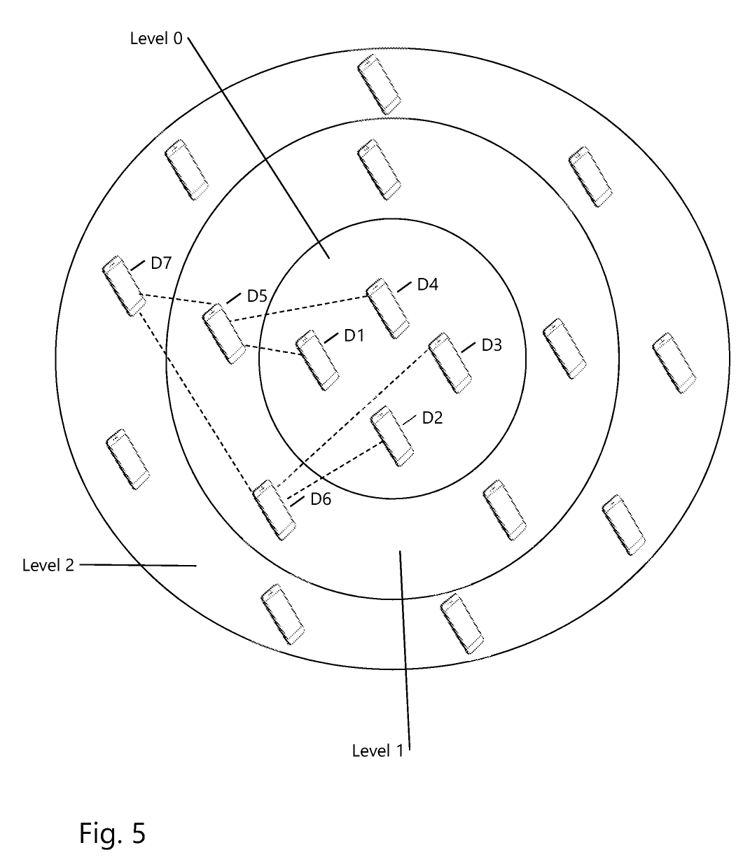

With reference to FIG. 5, a relationship diagram showing associations between mobile payment devices in levels 0-2 is illustrated in accordance with a non-limiting embodiment of the present disclosure. For example, devices D1-7 are mobile payment devices in the universe of devices used in CNP transactions. In this example, devices D1-4 have been previously associated with confirmed instances of fraud. Device D5 has shared common accounts with devices D1 and D4, while device D6 has shared common accounts with devices D2 and D3. For example, a sharing a common account may require that an account has been used on each of the devices. The shared account may be a fraudulent account, meaning it has been associated with at least one previous fraudulent transaction, or a clean account, meaning it has not been associated with any fraudulent activity. In certain embodiments, various other factors such as those described above effect the relationships drawn between devices and impact the level boundary lines. Continuing on with this example, device D7 in level 2 is related to devices D5 and D6 from level 1.

Suspicion scoring can proceed according to any of the mechanisms described above. For example, device D1 is associated with 1 fraudulent transaction and 10 total transactions, and D4 is associated with 4 fraudulent transactions and 10 total transactions. The suspicion scores for D1 and D4 are 0.1 and 0.4 respectively. The raw average suspicion score for D5 may be 0.25 based on the related level 0 devices. The raw average suspicion score for D5 can be multiplied by some multiplier that quantifies the number of related level 0 devices. For example, the multiplier may be 2 when there are 2 related devices. The modified raw average score for D5 would thus be 0.5. In certain embodiments, a dampening factor is applied to the D5 device corresponding to its level. For example, the dampening factor applied to level 1 devices may be 0.8. Thus, the final suspicion score for D5 may be 0.4. Suspicion score calculations may continue on up the level hierarchy such as for devices D6 and D7, and other devices in levels 1, 2, and beyond. The suspicion scores are then used to trigger additional authentication and verification steps or to block transactions according to the configurations described above.

The flowcharts and diagrams described herein illustrate the architecture, functionality, and operation of possible implementations of systems, methods, and computer program products according to various aspects of the present disclosure. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a,” “an,” and “the” are intended to comprise the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, “each” means “each and every” or “each of a subset of every,” unless context clearly indicates otherwise.

The corresponding structures, materials, acts, and equivalents of means or step plus function elements in the claims below are intended to comprise any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. For example, this disclosure comprises possible combinations of the various elements and features disclosed herein, and the particular elements and features presented in the claims and disclosed above may be combined with each other in other ways within the scope of the application, such that the application should be recognized as also directed to other embodiments comprising other possible combinations. The aspects of the disclosure herein were chosen and described in order to best explain the principles of the disclosure and the practical application and to enable others of ordinary skill in the art to understand the disclosure with various modifications as are suited to the particular use contemplated.

What is claimed is:

1. A method comprising:
by a computing device, determining, for each device in a first set of devices associated with a fraudulent transaction initiated by a plurality of flagged accounts, a suspicion score based on a number of fraudulent transactions associated with the device;
by the computing device, determining a relationship between each device in the first set and other devices in a second set that have initiated at least one legitimate transaction using at least one of the plurality of flagged accounts;
by the computing device, for each device in the second set, determining an average suspicion score based on the suspicion score for each device in the first set that is related to the device in the second set; and
by the computing device, in response to determining that the average suspicion score for a particular device in the second set is above a threshold, blocking a pending transaction involving the particular device.

2. The method of claim 1, further comprising applying a weighting factor to each average suspicion score, wherein the weighting factor is commensurate with a distance between the device for the average suspicion score and each related device in the first set.

3. The method of claim 1, further comprising determining a relationship between each device in the second set and other devices in a third set based on common unflagged accounts between devices in the second and third set.

4. The method of claim 3, wherein the third set excludes any devices from the first and second sets.

5. The method of claim 1, wherein the second set excludes any devices from the first set.

6. The method of claim 3, wherein the common unflagged accounts between devices in the second and third set exclude any flagged accounts.

7. The method of claim 6, further comprising determining an average suspicion score for each device in the third set and applying a weighting factor based on a total number of related devices to each average suspicion score for each device in each of the second and third sets.

8. The method of claim 7, wherein the average suspicion score is determined for each device in the third set based on the average suspicion score for each related device in the second set.

9. The method of claim 8, further comprising applying a respective weighting to each average suspicion score for the second and third sets, wherein the weighting is lower for devices in the third set.

10. The method of claim 9, further comprising in response to determining that the average suspicion score for a second particular device in the third set is above a threshold, requesting additional authentication information from an account holder for a second pending transaction involving the second particular device.

11. A computer configured to access a storage device, the computer comprising:
a processor; and
a non-transitory, computer-readable storage medium storing computer-readable instructions that when executed by the processor cause the computer to perform:
determining, for each device in a first set of devices associated with a fraudulent transaction initiated by a plurality of flagged accounts, a suspicion score based on a number of fraudulent transactions associated with the device, wherein each device in the first set of devices is a mobile payment device using near-field-communication to initiate payment transactions with a merchant terminal;
determining a relationship between each device in the first set and other devices in a second set that have initiated at least one legitimate transaction using at least one of the plurality of flagged accounts, wherein the determined relationship is based on a common transaction account used between devices in each set;
for each device in the second set, determining an average suspicion score based on the suspicion score for each device in the first set that is related to the device in the second set; and
in response to determining that the average suspicion score for a particular device in the second set is above a threshold, blocking a pending transaction involving the particular device and enforcing additional authentication measures based on the average suspicion score.

12. The computer of claim 11, wherein the computer-readable instructions further cause the computer to perform applying a weighting factor to each average suspicion score.

13. The computer of claim 11, wherein the computer-readable instructions further cause the computer to perform determining a relationship between each device in the second set and other devices in a third set based on common unflagged accounts between devices in the second and third set.

14. The computer of claim 13, wherein the third set excludes any devices from the first and second sets.

15. The computer of claim 11, wherein the second set excludes any devices from the first set.

16. The computer of claim 13, wherein the common unflagged accounts between devices in the second and third set exclude any flagged accounts.

17. The computer of claim 16, wherein the computer-readable instructions further cause the computer to perform determining an average suspicion score for each device in the third set.

18. The computer of claim 17, wherein the average suspicion score is determined for each device in the third set based on the average suspicion score for each related device in the second set.

19. The computer of claim 18, wherein the computer-readable instructions further cause the computer to perform applying a respective weighting to each average suspicion score for the second and third sets, wherein the weighting is lower for devices in the third set.

20. A non-transitory computer-readable medium having instructions stored thereon that is executable by a computing system to perform operations comprising:
determining, for each device in a first set of devices associated with a fraudulent transaction initiated by a plurality of flagged accounts, a suspicion score based on a number of fraudulent transactions associated with the device, wherein each device in the first set of devices is a mobile payment device used to initiate card-not-present transactions;
determining a relationship between each device in the first set and other devices in a second set that have initiated at least one legitimate transaction using at least one of the plurality of flagged accounts, wherein the determined relationship is based on a common transaction account used between devices in each set;
for each device in the second set, determining an average suspicion score based on the suspicion score for each device in the first set that is related to the device in the second set;
determining a relationship between each device in the second set and other devices in a third set based on common accounts used between devices in each set;
for each device in the third set, determining an average suspicion score based on the average suspicion score for each device in the second set that is related to the device in the third set;
applying a distance dampening factor to the average suspicion score for each device in the second and third set, wherein the distance dampening factor is higher for devices in the third set than for devices in the second set; and
in response to determining that the average suspicion score for a particular device in the second or third set is above a threshold, blocking a pending transaction involving the particular device and enforcing additional authentication measures based on the average suspicion score.
